(19) United States
(12) Patent Application Publication
(10) Pub. No.: US 2006/0055251 A1
(43) Pub. Date: Mar. 16, 2006

(54) Tubular linear motor for electrical discharge machine

(76) Inventor: Shun-Hsing Hsian, Taichung (TW)

Correspondence Address: CHARLES E. BAXLEY, ESQ., 90 JOHN STREET, THIRD FLOOR, NEW YORK, NY, 10038, US

(21) Appl. No.: 10/942,708

(22) Filed: Sep. 15, 2004

(51) Int. Cl. H02K 41/00

(52) U.S. Cl. 310/12

(57) ABSTRACT

A tubular linear motor for electrical discharge machine generally comprises: a stator, a forcer, a set of coils and a hollow central shaft. The forcer is mounted onto the hollow central shaft, the forcer and the hollow central shaft are slidably disposed at the axial center of the stator, the set of coils is disposed in the stator (or in the forcer). After the coil is powered, the forcer will be driven to reciprocate along the central shaft by the electromagnetic force produced by the set of coils. The central shaft can be interiorly provided with wires, and thus, both the production cost and installation space of the linear motor of the present invention can be substantially reduced.

### BACKGROUND OF THE INVENTION

1. Field of the Invention

The present invention relates to a tubular linear motor for electrical discharge machine, and more particularly to a tubular linear motor for electrical discharge machine wherein a forcer and a central shaft of which are slidably disposed at axle center of the stator, by taking advantage of electromagnetic forces caused by coils in the stator (or forcer) to actuate motion of the forcer, the forcer is driven to move by stable electromagnetic forces and the inner space of the hollow central shaft can be provided for receiving different kinds of wires, such that the volume and control complexity of the linear motor of the present invention can be substantially reduced.

2. Description of the Prior Arts

Referring to FIG. 1, which shows a conventional linear motor used on electrical discharge machine is shown, wherein two sets of coils 10 at both sides of the linear motor are used to generate electromagnetic force in vertical direction (as disclosed in U.S. Pat. No. 6,353,199 B1), the coils 10 are interiorly provided with plural sections of coils 13. A vertical tool electrode 11 is disposed on a slide track and located between the two sets of coils 10. On the outer surface of the tool electrode 11 is provided with plural magnets 12 in response to the multi-sections of coils 13. Through the interaction between the magnets 12 and the electromagnetic force produced by the two sets of coils 10, the vertical tool electrode 11 can be caused to slide in vertical direction. This kind of linear motor has been widely used on electrical discharge machines. However, there are still some disadvantages will be caused in operation:

First, since each set of the coils 10 is interiorly provided with multi-sections of coils 13, and the electromagnetic forces of the respective sections of coils 13 should be controlled precisely, the control circuit system of this conventional linear motor must be very complicated, the conductor arrangement of is also complicated. As a result, the production cost is increased.

Second, the vertical tool electrode 11 and the magnets 12 are located between the two sets of coils 10, thereby the electromagnetic forces between the two sets of coils 10 should be very accurately adjusted, otherwise the vertical tool electrode 11 will be damaged for being influenced by the uneven electromagnetic forces at both sides. As a result, the service life of the linear motor will be substantially reduced.

Third, since the vertical tool electrode 11 and the two sets of coils 10 are arranged in a row, thus occupying a large installation space, and as a result, the working space for the electrical discharge machine is relatively reduced.

The present invention has arisen to mitigate and/or obviate the afore-described disadvantages of the conventional linear motor for electrical discharge machine.

### SUMMARY OF THE INVENTION

The primary object of the present invention is to provide a low-cost tubular linear motor for electrical discharge machine, wherein a forcer which equipped with vertical tool electrode is slidably provided at axle center of a stator, a set of coils is disposed in the stator (or the forcer) so as not only to improve the control complexity of the multiple sets of coils of conventional linear motor, but also reduce the cost of the coils.

The secondary object of the present invention is to provide a tubular linear motor for electrical discharge machine with small volume but having bigger strength, wherein a central shaft and the forcer are defined in the stator, the central shaft is further interiorly provided with inner space for receiving different kinds of wires, such that the volume corresponding to the linear motor is substantially saved. Furthermore, the set of coils has large radius and long length, and the whole periphery of the forcer can be fully affected by electromagnetic forces, in this case, the electromagnetic forces produced by the tubular linear motor in accordance with the present invention can be improved.

The third object of the present invention is to provide a tubular linear motor for electrical discharge machine that does not require too much adjusting and checking before operation. Wherein the central shaft, the forcer, the stator and the set of coils are concentrically arranged, by this arrangement, the electromagnetic force caused by the coils can be used to evenly attract the forcer, such that the attractive forces between the stator and the forcer are balanced.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is a perspective view of a conventional linear motor for electrical discharge machine;

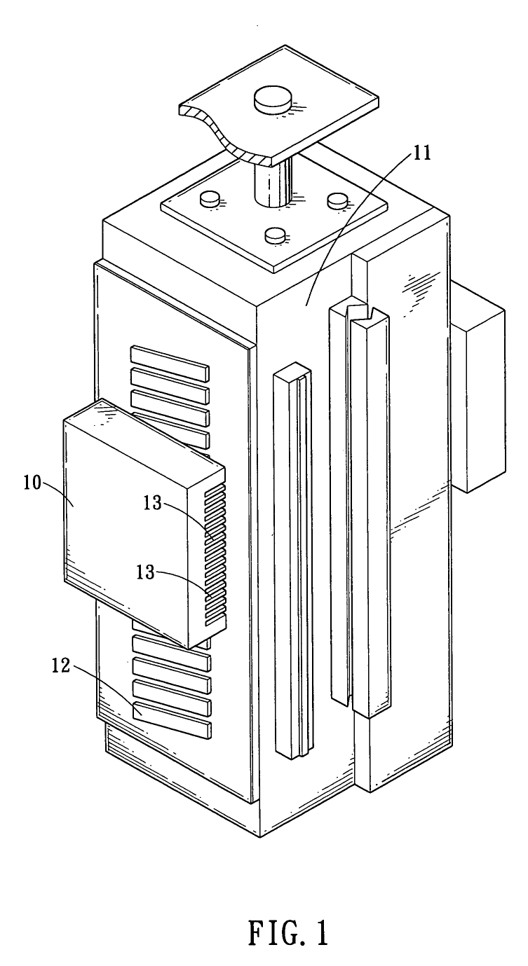

FIG. 2 is a perspective view of a tubular linear motor for electrical discharge machine in accordance with the present invention;

FIG. 3 is a cross sectional assembly view of the tubular linear motor for electrical discharge machine in accordance with the present invention;

FIG. 4 is a perspective view of a tubular linear motor for electrical discharge machine in accordance with another embodiment of the present invention;

### DETAILED DESCRIPTION OF THE PREFERRED EMBODIMENTS

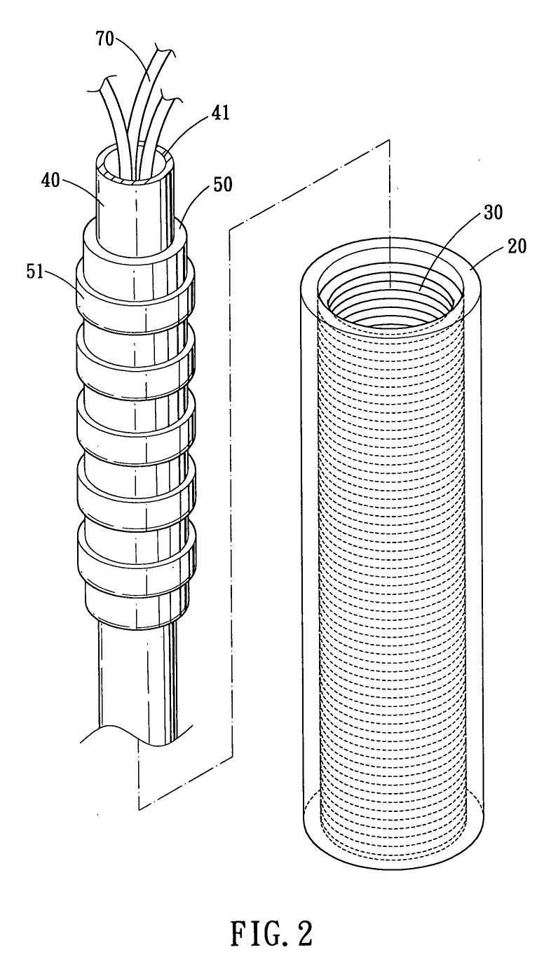

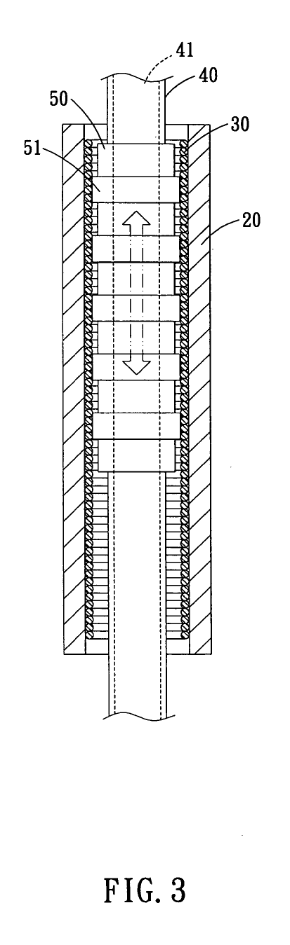

Referring to FIGS. 2 and 3, a tubular linear motor in accordance with the present invention is shown and generally including: a stator 20, a set of coils 30, a central shaft 40 and a forcer 50.

The stator 20 is a hollow tubular member and fixed at a predetermined position of an electrical discharge machine.

The set of coils 30 are disposed on the internal surface of the stator 20, the direction of the electric energy of the set of coils 30 is controlled by a control system of the electrical discharge machine.

The central shaft 40 is a hollow tubular member interiorly defined with a space 41, in which provided different kinds of wires 70. The central shaft 40 is located at the axial center of the stator 20 for discharging electric energy.

The forcer 50 is also a hollow tubular member slidably mounted onto the outer peripheral surface of the central shaft 40 and is provided with a vertical tool electrode (exemplary but not limiting). A plurality of permanent magnets 51 corresponding to the set of coils 30 are annularly provided on the forcer 50 and are equidistant from the set of coils 30. The permanent magnets 51 and the central shaft 40 can be driven to move by the electromagnetic force produced by the set of coils 30. And thus, the vertical tool electrode on the vertical axis of the central shaft 40 is able to slide back for cleaning operation after it finished the discharging toward a surface of a work piece.

Referring to FIG. 3, since the vertical tool electrode at an end of the central shaft 40 is controlled by the electrical discharge machine and used as discharge electrode for electro-discharge machining, a great number of residual wastes will be left on the periphery of vertical tool electrode after each time of charge discharge. At this moment, the vertical tool electrode must to clean up the wastes (this vertical tool electrode is used as a cleaner). The set of coils 30 on the internal surfaces of the stator 20 will be powered and produces a downward electromagnetic force, under the influence of the downward electromagnetic force generated by the set of coils 30, the permanent magnets 51 can drive the forcer 50 to move downward. At this moment, due to the respective permanent magnets 51 are equidistant from the set of coils 30, and the peripheral sides of the forcer 50 are synchronously affected by the downward electromagnetic force, the forcer 50 is able to steadily drive the central shaft 40 and the vertical tool electrode to slide back at high speed. At each time the vertical tool electrode slides back, it can be rinsed with rinsing liquid (the residual wastes are rinsed away). After that, a reverse current is applied to the set of coils 30 in the stator 20 for producing an upward electromagnetic force, and thus the forcer 50 will instantly drive the central shaft 40 and the vertical tool electrode to slide forward at high speed. It can be learned from the above descriptions that the vertical tool electrode of the forcer 50 is driven to move by even and stable electromagnetic forces, thus the operational stability of the respective components of the present invention at high-speed is maintained. In addition, the present invention only requires one set of coils 30, thus, the mutual interference between multiple sets of coils of the conventional linear motor can be avoided, the linear motor can be controlled more easily, and the production cost is also reduced.

It will be noted that the central shaft 40, the forcer 50 and the set of coils 30 are concentrically arranged in the stator 20, thus the space of the tubular linear motor in accordance with the present invention can be used efficiently (unlike the components of conventional linear motor that must be arranged in a row). Furthermore, the respective wires 70 can be disposed in the internal space 41 of the central shaft 40, thereby the linear motor of the present invention is truly smaller than the conventional linear motor. On the other hand, since the diameter and the length of the single set of coils 30 are great, and the whole peripheral sides of the forcer 50 are influenced evenly by the electromagnetic force caused by the set of coils 30, the electromagnetic force of the present invention will be much improved with respect to the conventional products.

Most important is that the device in accordance with the present invention is a tubular linear motor whose central shaft 40, forcer 50 and set of coils 30 are concentrically provided inside the stator 20, and thus the electromagnetic force produced by the set of coils 30 can be acted on the forcer 50 more evenly and synchronously, thus eliminating the problem of the disordered electromagnetic forces produced by the conventional device. Thanks to the concentric locating technology (conventional linear motor must be provided between the electromagnetic elements with passive elements), the forcer 50 in accordance with the present invention can be prevented from being influenced by electromagnetic forces caused by other coils.

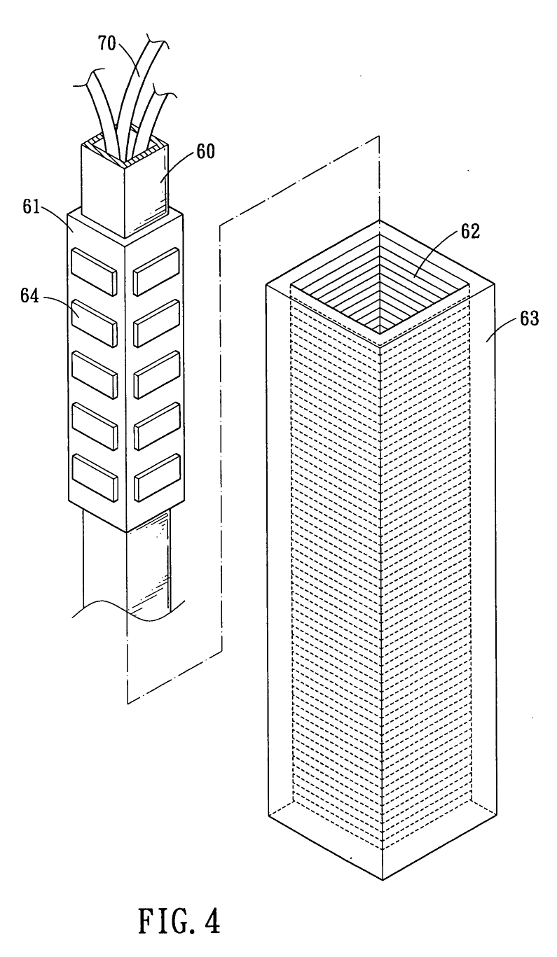

Referring further to FIG. 4, which shows a tubular linear motor for electrical discharge machine in accordance with another embodiment of the present invention, wherein a central shaft 60, a forcer 61, a coil 62 and a stator 63 of the linear motor can be square-shaped, on the outer surface of the square-shaped forcer 61 are provided plural permanent magnets 64. Since square tube structure has a one-dimensional locating function, operational stability and accuracy of the present invention will be improved.

It should be noted that the set of coils 30 on the stator 20 can be interchanged in position with the permanent electromagnets 51 on the forcer 50, by this arrangement, the forcer 50 is still slidable. It should be understood that this variation is functional equivalent is within the scope of the invention. The permanent magnets 51 are designed to produce a magnetic field in response to the set of coils 30, thus it can be replaced by a set of coils (not shown). Furthermore, the permanent magnets 51 also can be replaced by general magnetic material due to the magnetic material can produce magnetization in a magnetic field.

While we have shown and described various embodiments in accordance with the present invention, it should be clear to those skilled in the art that further embodiments may be made without departing from the scope of the present invention.

What is claimed is:

1. A tubular linear motor for electrical discharge machine employed to be assembled on a vertical shaft of an electrical discharge machine and generally comprising:
a stator which is a hollow tubular member and fixed to the electrical discharge machine;
a central shaft is a hollow tubular member interiorly defined with a space for accommodation of power wires, the central shaft located at an axle center of the stator and connected to vertical tool electrode;
a set of coils disposed in the stator, the direction of electric energy of the set of coils is controlled by control system of the electrical discharge machine;
a forcer is a hollow tubular member slidably disposed between the central shaft and the stator and can be driven to slide by electromagnetic force, the forcer is driven by electromagnetic force produced by the set of coils to slide relative to the stator.

2. The tubular linear motor for electrical discharge machine as claimed in claim 1, wherein the forcer is annularly provided with permanent magnets corresponding to the set of coils, the respective permanent magnets are equidistant from the set of coils, the permanent magnets can be driven to slide by electromagnetic force, the permanent magnets are driven to push the forcer to slide by the electromagnetic force produced by the set of coils.

3. The tubular linear motor for electrical discharge machine as claimed in claim 1, wherein the central shaft, the forcer and the stator are square-shaped tubular members.

4. The tubular linear motor for electrical discharge machine as claimed in claim 1, wherein the forcer is provided at its outer surface with a set of coils which serve to generate electromagnetic force for driving the forcer to slide.
